(19) United States
(12) Patent Application Publication
(10) Pub. No.: US 2003/0137993 A1
(43) Pub. Date: Jul. 24, 2003

(54) Method of managing time slots in a wireless network through the use of contention groups

(76) Inventor: Knut T. Odman, Vienna, VA (US)

Correspondence Address: XtremeSpectrum, Inc., 8133 Leesburg Pike, Suite 700, Vienna, VA, 22182, US

(21) Appl. No.: 10/347,824

(22) Filed: Jan. 22, 2003

Related U.S. Application Data
(60) Provisional application No. 60/349,351, filed on Jan. 22, 2002.

(51) Int. Cl. H04J 3/16

(52) U.S. Cl. 370/468; 370/458

(57) ABSTRACT

A method is provided for passing management frames between a network coordinator and a plurality of devices during a plurality of repeating superframes. The superframes are divided into repeating groups of consecutive superframes that form a superframe cycle. Each superframe has a set number of management time slots in it, which number can change. This creates a number of unique management time slots in each superframe cycle based on the number of superframes per cycle and the number of management time slots per superframe. The devices are assigned to a number of contention groups equal to the total number of management time slots in a superframe cycle. Each contention group is assigned a unique management time slot, and each device can only send management requests to the coordinator during the unique management time slot assigned to its contention group. Contention groups may have zero or one device in them.

### CROSS-REFERENCE TO RELATED PATENT DOCUMENTS

This application relies for priority on U.S. provisional application serial No. 60/349,351, by Knut T. Odman, filed Jan. 22, 2002, entitled “EFFECTIVE USE OF MANAGEMENT TIME SLOTS BY THE USE OF CONTENTION GROUPS USING SLOTTED ALOHA,” the contents of which is hereby incorporated by reference in its entirety.

### BACKGROUND OF THE INVENTION

The present invention relates to wireless personal area networks and wireless local area networks. More particularly, the present invention relates to a method for managing the assignment of management time slots in a wireless network through the use of contention groups.

The International Standards Organization's (ISO) Open Systems Interconnection (OSI) standard provides a seven-layered hierarchy between an end user and a physical device through which different systems can communicate. Each layer is responsible for different tasks, and the OSI standard specifies the interaction between layers, as well as between devices complying with the standard.

FIG. 1 shows the hierarchy of the seven-layered OSI standard. As seen in FIG. 1, the OSI standard 100 includes a physical layer 110, a data link layer 120, a network layer 130, a transport layer 140, a session layer 150, a presentation layer 160, and an application layer 170.

The physical (PHY) layer 110 conveys the bit stream through the network at the electrical, mechanical, functional, and procedural level. It provides the hardware means of sending and receiving data on a carrier. The data link layer 120 describes the representation of bits on the physical medium and the format of messages on the medium, sending blocks of data (such as frames) with proper synchronization. The networking layer 130 handles the routing and forwarding of the data to proper destinations, maintaining and terminating connections. The transport layer 140 manages the end-to-end control and error checking to ensure complete data transfer. The session layer 150 sets up, coordinates, and terminates conversations, exchanges, and dialogs between the applications at each end. The presentation layer 160 converts incoming and outgoing data from one presentation format to another. The application layer 170 is where communication partners are identified, quality of service is identified, user authentication and privacy are considered, and any constraints on data syntax are identified.

The IEEE 802 Committee has developed a three-layer architecture for local networks that roughly corresponds to the physical layer 110 and the data link layer 120 of the OSI standard 100. FIG. 2 shows the IEEE 802 standard 200.

As shown in FIG. 2, the IEEE 802 standard 200 includes a physical (PHY) layer 210, a media access control (MAC) layer 220, and a logical link control (LLC) layer 225. The PHY layer 210 operates essentially as the PHY layer 110 in the OSI standard 100. The MAC and LLC layers 220 and 225 share the functions of the data link layer 120 in the OSI standard 100. The LLC layer 225 places data into frames that can be communicated at the PHY layer 210; and the MAC layer 220 manages communication over the data link, sending data frames and receiving acknowledgement (ACK) frames. Together the MAC and LLC layers 220 and 225 are responsible for error checking as well as retransmission of frames that are not received and acknowledged.

FIG. 3 is a block diagram of a wireless network 300 that could use the IEEE 802 standard 200. In a preferred embodiment the network 300 is a wireless personal area network (WPAN), or piconet. However, it should be understood that the present invention also applies to other settings where bandwidth is to be shared among several users, such as, for example, wireless local area networks (WLAN), or any other appropriate wireless network.

When the term piconet is used, it refers to a network of devices connected in an ad hoc fashion, having one device act as a coordinator (i.e., it functions as a server) while the other devices (sometimes called stations) follow the time allocation instructions of the coordinator (i.e., they function as clients). The coordinator can be a designated device, or simply one of the devices chosen to function as a coordinator. One primary difference between the coordinator and non-coordinator devices is that the coordinator must be able to communicate with all of the devices in the network, while the various non-coordinator devices need not be able to communicate with all of the other non-coordinator devices.

As shown in FIG. 3, the network 300 includes a coordinator 310 and a plurality of non-coordinator devices 320. The coordinator 310 serves to control the operation of the network 300. As noted above, the system of coordinator 310 and non-coordinator devices 320 may be called a piconet, in which case the coordinator 310 may be referred to as a piconet coordinator (PNC). Each of the non-coordinator devices 320 must be connected to the coordinator 310 via primary wireless links 330, and may also be connected to one or more other non-coordinator devices 320 via secondary wireless links 340, also called peer-to-peer links.

In addition, although FIG. 3 shows bi-directional links between devices, they could also be unidirectional. In this case, each bi-directional link 330, 340 could be shown as two unidirectional links, the first going in one direction and the second going in the opposite direction.

In some embodiments the coordinator 310 may be the same sort of device as any of the non-coordinator devices 320, except with the additional functionality for coordinating the system, and the requirement that it communicate with every device 320 in the network 300. In other embodiments the coordinator 310 may be a separate designated control unit that does not function as one of the devices 320.

Through the course if the following disclosure the coordinator 310 will be considered to be a device just like the non-coordinator devices 320. However, alternate embodiments could use a dedicated coordinator 310. Furthermore, individual non-coordinator devices 320 could include the functional elements of a coordinator 310, but not use them, functioning as non-coordinator devices. This could be the case where any device is a potential coordinator 310, but only one actually serves that function in a given network.

Each device of the network 300 may be a different wireless device, for example, a digital still camera, a digital video camera, a personal data assistant (PDA), a digital music player, or other personal wireless device.

The various non-coordinator devices 320 are confined to a usable physical area 350, which is set based on the extent to which the coordinator 310 can successfully communicate with each of the non-coordinator devices 320. Any non-coordinator device 320 that is able to communicate with the coordinator 310 (and vice versa) is within the usable area 350 of the network 300. As noted, however, it is not necessary for every non-coordinator device 320 in the network 300 to communicate with every other non-coordinator device 320.

FIG. 4 is a block diagram of a device 310, 320 from the network 300 of FIG. 3. As shown in FIG. 4, each device (i.e., each coordinator 310 or non-coordinator device 320 ) includes a physical (PHY) layer 410, a media access control (MAC) layer 420, a set of upper layers 430, and a management entity 440.

The PHY layer 410 communicates with the rest of the network 300 via a primary or secondary wireless link 330 or 340. It generates and receives data in a transmittable data format and converts it to and from a format usable through the MAC layer 420.

The MAC layer 420 serves as an interface between the data formats required by the PHY layer 410 and those required by the upper layers 430. It may include a MAC layer management entity (MLME) for managing the operation of the remainder of the MAC layer 420

The upper layers 430 include the functionality of the device 310,320. These upper layers 430 may include TCP/IP, TCP, UDP, RTP, IP, LLC, or the like.

The management entity 440 provides monitoring and control functions to the MAC layer 420 and the PHY layer 410, and facilitates communication between the upper layers and the MAC layer 420. The management entity 440 may include a device management entity (DME) for controlling the operation of the device 310, 320. In alternate embodiments the DME can be called a station management entity (SME).

Typically, the coordinator 310 and the non-coordinator devices 320 in a WPAN share the same bandwidth. Accordingly, the coordinator 310 coordinates the sharing of that bandwidth. Standards have been developed to establish protocols for sharing bandwidth in a wireless personal area network (WPAN) setting. For example, the IEEE standard 802.15.3 provides a specification for the PHY layer 410 and the MAC layer 420 in such a setting where bandwidth is shared using a form of time division multiple access (TDMA). Using this standard, the MAC layer 420 defines frames and superframes through which the sharing of the bandwidth by the devices 310, 320 is managed by the coordinator 310 and/or the non-coordinator devices 320.

Device IDs and MAC Addresses

One important aspect of working with devices 310, 320 in a network 300 is uniquely identifying each of the devices 310, 320. There are several ways in which this can be accomplished.

Independent of any network it is in, each device 310, 320 has a unique MAC address that can be used to identify it. This MAC address is generally assigned to the device by the manufacturer such that no two devices 310, 320 have the same MAC address. One set of standards that is used in preferred embodiments of the present invention to govern MAC addresses can be found in IEEE Std. 802-1990, “IEEE Standards for Local and Metropolitan Area Networks: Overview and Architecture.”

For ease of operation, the network 300 can also assign a device ID to each device 310, 320 in the network 300 to use in addition its unique MAC address. In the preferred embodiments the MAC 420 uses ad hoc device IDs to identify devices 310, 320. These device IDs can be used, for example, to route packets within the network 300 based on the ad hoc device ID of the destination of the packet. The device IDs are generally much smaller than the MAC addresses for each device 310, 320. In the preferred embodiments the device IDs are 4-bits and the MAC addresses are 48-bits.

Each device 310, 320 should maintain mapping table that maps the correspondence between device IDs and MAC addresses. The table is filled in based on the device ID and MAC address information provided to the non-coordinator devices 320 by the coordinator 310. This allows each device 310, 320 to reference themselves and the other devices in the network 300 by either device ID or MAC address.

In addition, a broadcast device ID can be set that is used to designate all of the devices at once. This can be used, for example, in situations where all of the devices are intended as the recipient of a data packet (or frame).

The present invention can be used with the IEEE 803.15.3 standard for high-rate WPANs, which is currently under development by the IEEE 802.15 WPAN™ Task Group 3 (TG3). The details of the current draft 802.15.3 standard, including archives of the 802.15.3 working group can be found at: http://www.ieee802.org/15/pub/TG3.html. Nothing in this disclosure should be considered to be incompatible with the draft 802.15.3 standard, as set forth on the IEEE 802 LAN/MAN Standards Committee web page.

Superframes

The available bandwidth in a given network 300 is split up in time by the coordinator 310 into a series of repeated superframes. These superframes define how the available transmission time is split up among various tasks. Individual frames of data are then transferred within these superframes in accordance with the timing set forth in the superframe.

FIG. 5 is a block diagram of a superframe according to preferred embodiments of the present invention. As shown in FIG. 5, each superframe 500 may include a beacon period 510, a contention access period (CAP) 520, and a contention free period (CFP) 530.

The beacon period 510 is set aside for the coordinator 310 to send a beacon frame out to the non-coordinator devices 320 in the network 300. Such a beacon frame will include information for organizing the operation of devices within the superframe. Each non-coordinator device 320 knows how to recognize a beacon 510 prior to joining the network 300, and uses the beacon 510 both to identify an existing network 300 and to coordinate communication within the network 300.

The CAP 520 is used to transmit commands or asynchronous data across the network. The CAP 520 may be eliminated in many embodiments and the system would then pass commands solely during the CFP 530.

The CFP 530 includes a plurality of time slots 540. These time slots 540 are assigned by the coordinator 310 to a single transmitting device 310, 320 and one or more receiving devices 310, 320 for transmission of information between them. Generally each time slot 540 is assigned to a specific transmitter-receiver pair, though in some cases a single transmitter will transmit to multiple receivers at the same time. Exemplary types of time slots are: management time slots (MTS) and guaranteed time slots (GTS).

An MTS is a time slot that is used for transmitting administrative information between the coordinator 310 and one of the non-coordinator devices 320. As such it must have the coordinator 310 be one member of the transmission pair. An MTS may be further defined as an uplink MTS (UMTS) if the coordinator 310 is the receiving device, or a downlink MTS (DMTS) if the coordinator 310 is the transmitting device.

A GTS is a time slot that is used for transmitting isochronous non-administrative data between devices 310, 320 in the network 300. This can include data transmitted between two non-coordinator devices 320, or non-administrative data transmitted between the coordinator 310 and a non-coordinator device 320.

As used in this application, a stream is a communication between a source device and one or more destination devices. The source and destination devices can be any devices 310, 320 in the network 300. For streams to multiple destinations, the destination devices can be all or some of the devices 310, 320 in the network 300.

In some embodiments the uplink MTS may be positioned at the front of the CFP 530 and the downlink MTS positioned at the end of the CFP 530 to give the coordinator 310 a chance to respond to an uplink MTS in the in the downlink MTS of the same superframe 500. However, it is not required that the coordinator 310 respond to a request in the same superframe 500. The coordinator 310 may instead respond in another downlink MTS assigned to that non-coordinator device 320 in a later superframe 500.

The superframe 500 is a fixed time construct that is repeated in time. The specific duration of the superframe 500 is described in the beacon 510. In fact, the beacon 510 generally includes information regarding how often the beacon 510 is repeated, which effectively corresponds to the duration of the superframe 500. The beacon 510 also contains information regarding the network 300, such as the identity of the transmitter and receiver of each time slot 540, and the identity of the coordinator 310.

The system clock for the network 300 is preferably synchronized through the generation and reception of the beacons 510. Each non-coordinator device 320 will store a synchronization point time upon successful reception of a valid beacon 510, and will then use this synchronization point time to adjust its own timing.

Although not shown in FIG. 5, there are preferably guard times interspersed between time slots 540 in a CFP 530. Guard times are used in TDMA systems to prevent two transmissions from overlapping in time because of inevitable errors in clock accuracies and differences in propagation times based on spatial positions.

In a WPAN, the propagation time will generally be insignificant compared to the clock accuracy. Thus the amount of guard time required is preferably based primarily on the clock accuracy and the duration since the previous synchronization event. Such a synchronizing event will generally occur when a non-coordinator device 320 successfully receives a beacon frame from the coordinator 310.

For simplicity, a single guard time value may be used for the entire superframe. The guard time will preferably be placed at the end of each beacon frame, GTS, ATS, and MTS.

The exact design of a superframe 500 can vary according to implementation. FIG. 6 shows an example of a specific superframe design. As shown in FIG. 6, the transmission scheme 600 involves dividing the available transmission time into a plurality of superframes 610. Each individual superframe 610 includes a beacon frame 620, an uplink MTS 630, a plurality of GTS 640, and a downlink MTS 660. This exemplary superframe includes no contention access period.

The beacon frame 620 indicates by association ID (known as a device ID in the IEEE 802.15.3 draft standard) a non-coordinator device 320 that is assigned to the current superframe 610. It also indicates via a receive-transmit table the transmitter/receiver assignments for the individual GTS 640.

In the exemplary superframe structure shown in FIG. 6, the uplink MTS 630 is set aside for the non-coordinator device 320 assigned to the current superframe 610 to upload signals to the coordinator 310. All other non-coordinator devices 320 remain silent on the current channel during this time slot. In alternate embodiments that use multiple channels, all other stations on that channel must remain silent during an uplink MTS 630, though they may still transmit on alternate channels.

The plurality of GTS 640 are the time slots set aside for each of the devices 310, 320 to allow communication between devices. They do so in accordance with the information set forth in the receive-transmit table in the beacon 620. Each GTS 640 is preferably large enough to transmit one or more data frames. When a transmitter-receiver set is assigned multiple GTS 640, they are preferably contiguous.

The downlink MTS 660 is set aside for the coordinator 310 to download signals to the non-coordinator device 320 assigned to the current superframe 610. All other non-coordinator devices 320 may ignore all transmissions during this time slot.

The lengths of the uplink and downlink MTS 630 and 660 must be chosen to handle the largest possible management frame, an immediate acknowledgement (ACK) frame, and the receiver-transmitter turnaround time. For the GTS 640, the length and number must be chosen to accommodate the specific requirements of frames to be transmitted, e.g., short MPEG frames, large frames of the maximum allowable length, and streaming vs. immediate ACK operation.

Although the disclosed embodiment uses a plurality of GTS 640, one uplink MTS 630 placed before the GTS 640, and one downlink MTS 660 placed after the GTS 640, the number, distribution, and placement of GTS 640 and MTS 630, 660 may be varied in alternate embodiments. Preferred embodiments of the present invention will be described below. And while the embodiments described herein will be in the context of a WPAN (or piconet), it should be understood that the present invention also applies to other settings where bandwidth is to be shared among several users, such as, for example, wireless local area networks (WLAN), or any other appropriate wireless network.

The present invention provides a way of assigning MTS in a way that is fair and efficient, even when the number of devices in the network 300 is greater than the number of available MTS.

### SUMMARY OF THE INVENTION

Consistent with the title of this section, only a brief description of selected features of the present invention is now presented. A more complete description of the present invention is the subject of this entire document.

An object of the present invention is to provide a method of assigning management time slots in a way that is fair and efficient.

Another object of the present invention is to create contention groups that distribute the devices in a network so that when the number of devices is greater than the number of available management time slots, the only a limited number of devices will compete for each management time slot.

These and other objects are accomplished by way of 1. A method of passing management frames between a coordinator and a plurality of devices during a plurality of repeated superframes, comprising: dividing the plurality of superframes into repeating groups of L consecutive superframes; forming M management time slots in each of the L consecutive superframes, such that N unique management time slots are created in the L consecutive superframes, where N is equal to L times M; dividing the plurality of devices into N contention groups; assigning each of the N contention groups to one of the N unique management time slots; allowing an individual device from the plurality of devices to send management requests to a network coordinator only during the unique management time slot to which the contention group that the individual device is a member of is assigned. In this method, L and M are preferably integers greater than 0, and N is preferably an integer greater than 1.

Each of the N contention groups preferably has no more than one more of the plurality of devices assigned to it than any other of the N contention groups.

L is preferably between 1 and 6, M is between 1 and 6, and N is between 4 and 127.

The management time frames are preferably uplink management time frames, used for passing signals from one of the plurality of devices to the network coordinator. Each of the L repeated superframes may further comprise downlink management time slots, used for passing signals from the network coordinator to each of the plurality of devices.

### BRIEF DESCRIPTION OF THE DRAWINGS

A more complete appreciation of the invention and its many attendant advantages will be readily obtained as it becomes better understood with reference to the following detailed description when considered in connection with the accompanying drawings, in which:

FIG. 1 is a diagram showing the hierarchy of the seven-layered OSI standard;

FIG. 2 is a diagram showing the hierarchy of the IEEE 802 standard;

FIG. 3 is a block diagram of a wireless network according to a preferred embodiment of the present invention;

FIG. 4 is a block diagram of a device from the network of FIG. 3;

FIG. 5 is a block diagram of a superframe according to preferred embodiments of the present invention;

FIG. 6 is a block diagram of a specific superframe design according to a preferred embodiment of the present invention; and

FIG. 7 is a block diagram showing two new devices trying to associate with an existing wireless network, according to a preferred embodiment of the present invention.

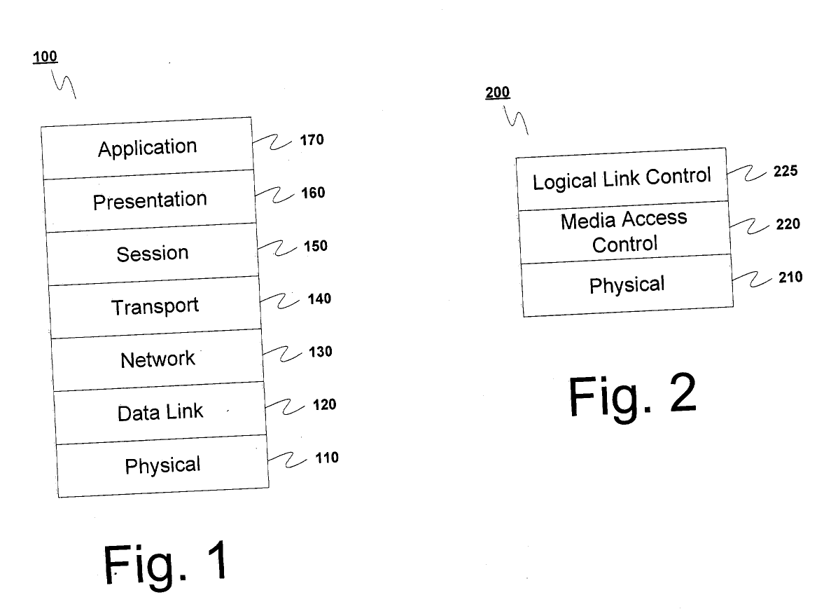

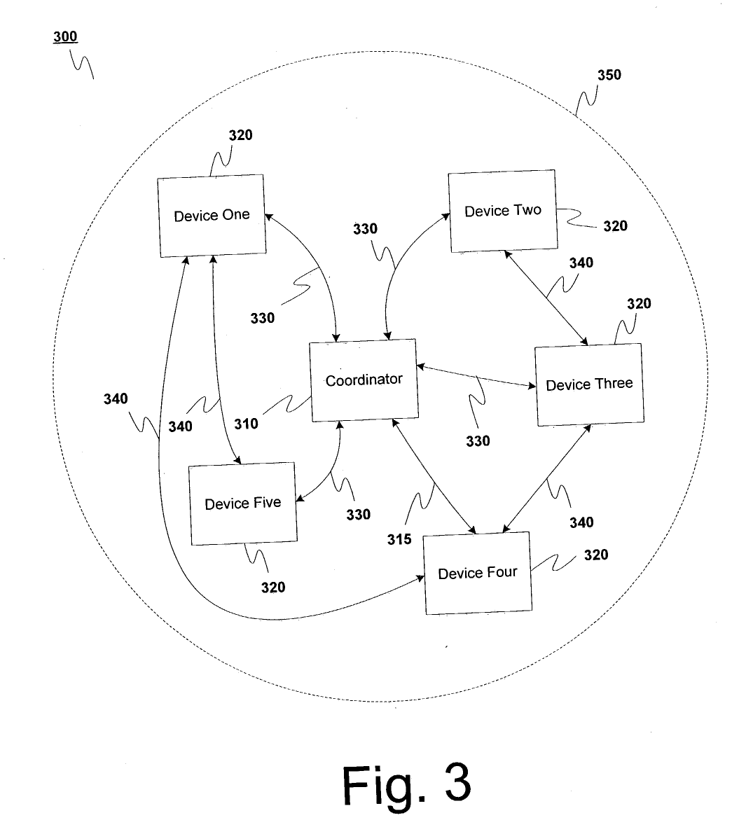

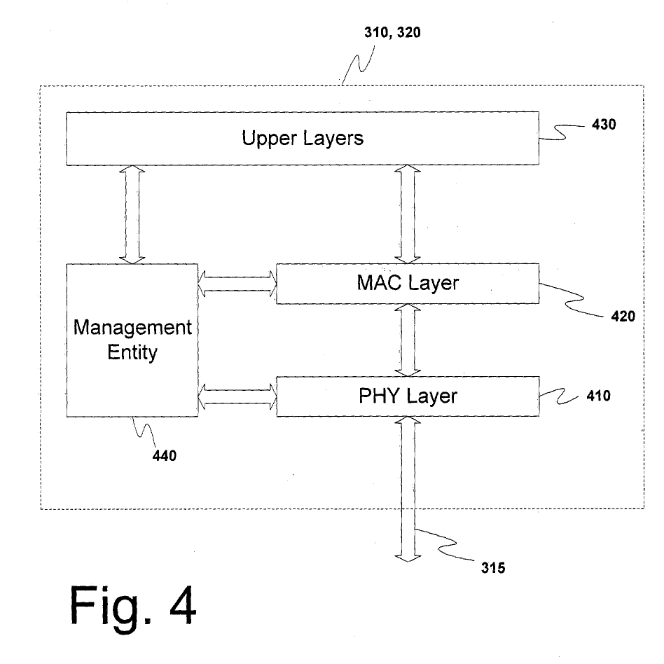

### DETAILED DESCRIPTION OF THE PREFERRED EMBODIMENTS

Preferred embodiments of the present invention will now be described with reference to the drawings. Throughout the several views, like reference numerals designate identical or corresponding parts.

The present invention relates to a system and method for allocating and using small fixed-size time slots to be used for management frames in short asynchronous data frames in a wireless transmission setting. The main objective is to eliminate all unnecessary contention between individual devices in a network while at the same time keeping throughput at a maximum and power use at a minimum.

Contention Defined

Contention occurs when there is no unambiguous way to tell which device should send a transmission at a certain time. In such a situation, two or more devices may end up competing for the same media (i.e., the airwaves) at the same time. Several protocols have been developed to deal with contention, such as carrier sense multiple access/collision avoidance (CSMA/CA) and Slotted Aloha.

Unfortunately, all solutions to reduce or eliminate contention ultimately result in a certain waste of bandwidth and power. This happens because if the protocol is designed to listen first to avoid collision, or to detect that a collision has occurred, the device will have to spend time listening and retrying. This is time that is not spent transmitting data. How much of a problem this is depends on the probability of collision, which in its turn depends on how many transmitting devices there are within hearing range of each other.

However, the operation of the protocol can be significantly enhanced if the number of possible collision times are reduced to a minimum. In addition, the less contention occurs in the system, the more predictable traffic will be. This is because when there is no contention each device will always know the next available time that it can safely transmit.

Nevertheless, contention can generally only be predicted and reduced within a given network, or possibly among adjacent networks using the same media access protocol and radio spectrum. Additional mechanisms may be necessary to cope with interference from unrelated sources.

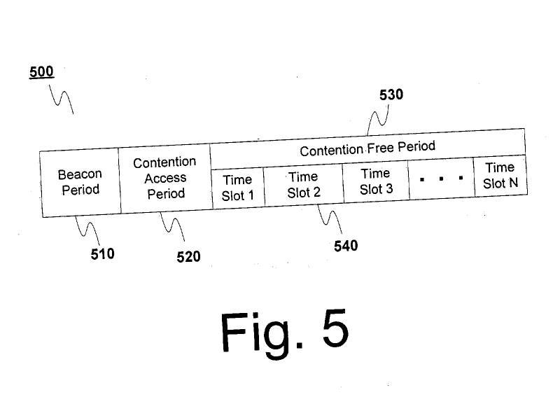

As shown in FIG. 5, one way to control contention is to set aside a contention access period (CAP) 520 in the superframe where all transmissions likely to cause contention will occur.

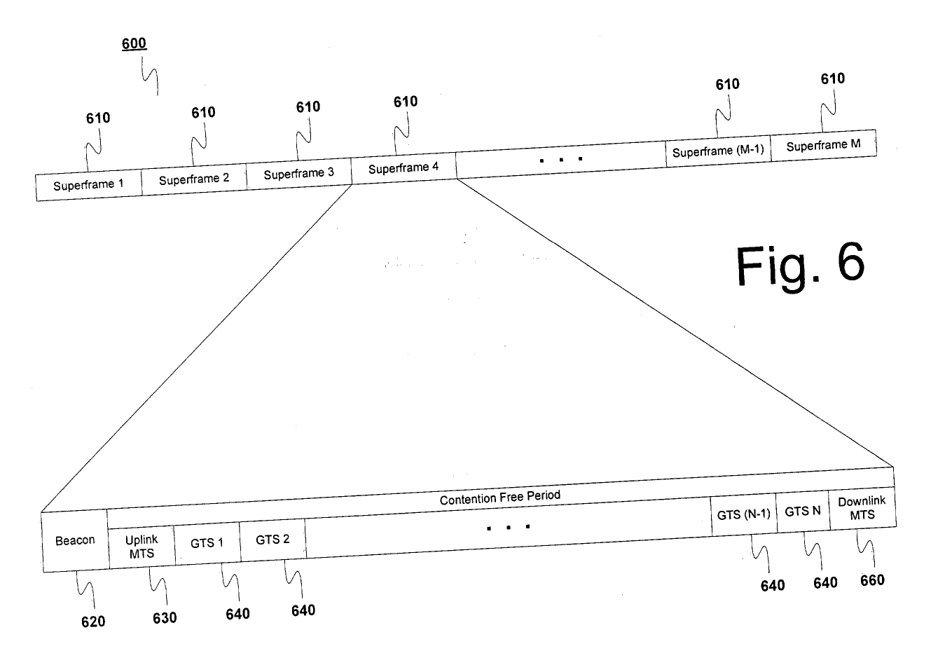

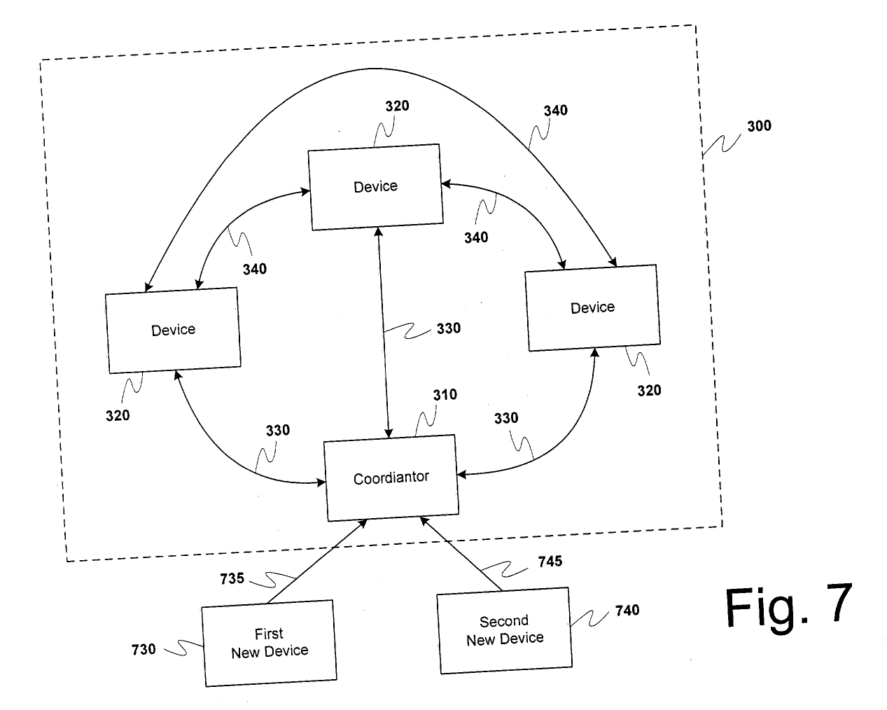

But, as shown in FIG. 6, in some alternate embodiments no CAP 520 is used. In this case, each superframe 710 includes one or more MTS that can be used for transmitting management information between the coordinator 310 and the non-coordinator devices 320. As noted above, the coordinator 310 preferably assigns the available MTS to the non-coordinator devices 320 in the network 300 in a fair distribution.

However, an MTS can only be assigned to non-coordinator device 320 when the particular device 320 is known to the coordinator 310. Preferably the coordinator 310 periodically sets aside one or more unassigned MTS for transmissions from unassigned devices, e.g., new devices requesting association. Since all association requests involve an unknown device, they cannot be done in an assigned MTS and must be done in an unassigned MTS with the possibility of contention, i.e., with the possibility that two or more devices will try and use the same MTS and their transmissions will collide. These MTS assigned to allow contention can be called contention MTS (CMTS). The CMTS are preferably always assigned to the broadcast device ID (i.e.),since they are not assigned to any individual device. Otherwise a CMTS looks like a normal MTS.

Contention in Practice

FIG. 7 is a block diagram showing two new devices trying to associate with an existing wireless network, according to a preferred embodiment of the present invention. As shown in FIG. 7, an existing network 300 includes a coordinator 310 and a plurality of non-coordinator devices 320. First and second new devices 730 and 740 are not connected to the existing network 300, but desire to associate with it.

In order to be capable of joining the existing network 300, both the first and second new devices 730 and 740 must be able to hear the coordinator 310 and be heard by the coordinator 310. In addition, both must be able to recognize the superframe structure that the network 300 is using. Each will listen to a number of superframes until it detects a suitable time slot for association (e.g., an unassigned MTS) and will then send an association frame to the coordinator 310 to try and associate with the network 300.

If each device chooses a different unassigned MTS to send its association frame, then there will be no contention and the two association requests will be processed properly. However, if they send their association requests during the same unassigned MTS, there will be contention. In this case there are two main possible results: either the two association requests will have a similar signal strength (e.g., the two new devices 730 and 740 are roughly the same distance away from the coordinator 310), or one association request will have a significantly higher signal strength than the other (e.g., the first new device 730 is closer to the coordinator 310 than is the second new device 740).

If the two association requests 735 and 745 are sent in the same unassigned MTS and have equal signal strengths, then they will interfere with each other and the coordinator 310 will be able to read neither. A cyclic redundancy check (CRC) on the incoming association requests will fail (since the requests overlap) and the coordinator will not reply to either request 735, 745.

As a result, both the first and the second new devices 730 and 740 will each have to send another association request 735, 745. Preferably a certain amount of randomness be introduced into their respective retry times to avoid future collisions. Otherwise the two would likely collide again at the next available MTS and so on, colliding forever and never associating with the network. This can be accomplished by simply having each new device 730, 740 wait a random amount of time before sending a new association request.

However, signal strengths are not always similar. In some situations the signal strength of one device (say, the first device 730) will be significantly stronger than that of the other device (say, the second device 740) Although both may be strong enough for the coordinator 310 to read if they were the only signals being transmitted, the signal strength of the first association request 735 may be strong enough to drown out the second association signal 745.

In this case the first association request 735 from the first new device 730 will be processed and the first new device will become associated with the network 300. There will be no contention since the coordinator 310 only heard the first association request 730 and never heard the second association request 745 from the second device 740. However, there must be some way for a given new device 730, 740 to determine whether a reply message is intended for it or a contending device. Otherwise when the coordinator 310 replied to the first association request 735, the first and second new devices 730 and 740 (who can both hear the coordinator 310) might consider it to be directed at them (after all, they both just send out an association request). One way to accomplish this would be to place a unique identifier (e.g., a 48-bit MAC address) for the requesting device 320 in the reply frame sent from the coordinator 310.

Generally, the only management frame that will always be sent during contention is the association request. No other frame needs to be sent under contention. This is because once a device is associated with the network 300, it should only use its own allocated MTS for communicating management frames to the coordinator 310.

However, networks 300 may support more advanced power saving modes that can allow for additional messages sent in contention. For example, a preferred power-saving scheme allows non-coordinator devices 320 that have no interest in using their allocated MTS to enter a deep sleep mode for a time. While in such a deep sleep mode, the device 320 voluntarily gives up its MTS, which the coordinator 310 may or may not reassign. Then, when the device 320 wakes up, it must send a message to the coordinator 310 indicating that it wants its MTS back. This wakeup message will generally also be sent under contention.

The coordinator 310 must reserve an MTS for all associated non-coordinator devices 320, even if that device 320 is not using it. If a non-coordinator devices 320 gives up its MTS to go into a deep sleep mode, the coordinator 310 may choose to not allocate that MTS in the beacon, i.e., not include the MTS in its normal spot in the superframe rotation. However, the coordinator 310 should not give the MTS away to another device. This is crucial so the coordinator 310 doesn't over-allocate the available MTS. In other words, this is so that the coordinator 310 does not give away a deep sleeping device's MTS and then not have an MTS to assign the device when it wakes up.

How to Detect a Lost Contention

As noted above, a device sending a request under contention will preferably supply information that makes it possible for the coordinator 310 to differentiate a reply to the requesting device from a reply to any other device. A preferred way to accomplish this is to have all requests under contention must pass the device's 48 bit MAC address as a parameter.

Likewise, the coordinator 310 will preferably include the MAC address of the “winning” device in its reply signal. This is the only way the requestor can tell if the coordinator heard its request or if a response is intended for another device.

How to Recover from a Lost Contention

Generally all algorithms for failing a contention look roughly the same: wait a random time and try again. As noted above, the randomness is important since otherwise two contenders could keep colliding forever.

Preferably the wait time will be long enough to assure that some randomness can be accomplished. But since this random time causes a significant and unpredictable delay in the request being handled, it means that all frames sent under contention may be delayed. Therefore, it is important that no unnecessary frames are sent under contention. Devices can generally wait for association and wakeup, since they have no other pending tasks. But devices 320 operating in the network 300 cannot suffer such delays without suffering a reduction in their operational efficiency.

Preferably one of two major waiting algorithms is used: CSMA/CA or Slotted Aloha. CSMA/CA sets a random time delay for each device and has them send a new request at the end of that time. Each delaying device should pause its timer countdown when it hears any other traffic being transmitted during the back-off time. Slotted Aloha assigns only certain slots for contention (CMTS in the preferred embodiments). If a collision occurs, it has each device wait a random number of such slots and then try again. Of these two, only Slotted Aloha is useful for TDMA protocols since TDMA protocols use assigned timeslots of appropriate size for all traffic.

MTS and CMTS Distribution and Allocation

An MTS allocation scheme will preferably allow devices in a sleep mode to refrain from using MTS. It will also preferably allow each device to predict when it has its MTS so it can enter a light sleep mode until then if it has no data to send or receive. In some alternate embodiments, however, devices will have to listen to all MTS, and may not remain in a light sleep mode during any MTS, regardless of whom it is assigned to.

Furthermore, it is favorable not to tie the MTS allocation to the beacon number. This is because associations and disassociations of devices in the network constantly change the MTS allocation. And it is better for sleeping devices if the beacon structure stay reasonably constant, so it will remain predictable for longer periods of time, allowing devices to stay in a power-saving sleep mode for longer durations.

In the preferred embodiments CMTS are used only for new device association and device wakeup frames. CMTS are not needed in every superframe, but should be provided with some regularity, e.g., every second, third, or fourth superframe. Collisions in the CMTS are preferably solved by Slotted Aloha.

It is acceptable that it gets harder for a new device to enter the network as the network fills up. For example, depending upon the implementation, a coordinator 310 might reduce the number of available CMTS as the network fills up or allow them to remain the same. Regardless, as many more devices enter a network 300, they will use up a correspondingly larger amount of resources and make it harder for another device to enter the network 300.

Requirements for MTS

In its distribution and assignment of MTS, the coordinator 310 needs to be able to handle fragmentation. In other words, it must be able account for the disassociation of member devices, which leaves unused, but assigned MTS. The coordinator 310 must be able to reassign the MTS previously assigned to a now-disassociated device.

In various preferred embodiments there can be several MTS within a single superframe. Preferably their number will be limited so only a small part of the superframe used for MTS. This is because power consumption is fairly linear to the waking time of the devices 310, 320. And since in some embodiments all non-coordinator devices 320 except those in deep sleep modes must to listen during every MTS, the MTS part of the superframe is preferably kept to a minimum so that the non-coordinator devices 320 can minimize the time they must remain fully awake (and therefore reduce their power consumption).

As shown in FIG. 6, the MTS assigned to a particular non-coordinator device 320 are preferably divided into uplink MTS (for messages from the device 320 to the coordinator 310) and downlink MTS (for messages from the coordinator 310 to the device 320). The uplink and downlink MTS assigned to a particular device are preferably assigned within the same superframe, however. As shown in FIG. 6, most preferably the uplink MTS will be located in the beginning portion of the superframe and the downlink MTS will be located in the latter part of the superframe so that the coordinator 310 will have a chance to process any requests made by the device 320 in the uplink MTS and reply in the downlink MTS.

Assigned MTS preferably have a repetition rate such that that every associated device gets its fair access to an MTS. This is done by cycling beacons through an iterative sequence so that each non-coordinator device 320 will be assigned an MTS in a periodic superframe. Furthermore, the repetition rate is preferably short enough so that a given device can repeat a failed management frame within a reasonable time. For ease of implementation, it is preferable to use even binary cycle numbers, e.g., 2, 4, 8, etc.

If there are more associated devices than there are MTS in the repetition cycle, more than one device must be assigned to a given MTS in the same superframe.

In the preferred embodiment, there should be no more than four pairs of MTS per superframe, i.e., four uplink MTS and 4 downlink MTS. Preferably the number is kept below this maximum value when there are fewer devices 310, 320 in the network 300, and gradually raised as more devices 320 become associated. Increasing the amount of MTS per superframe by too great a step, e.g., from one per superframe to four per superframe, could cause problems. It is possible in some instances that there may not be enough space in the superframe to currently allocate enough MTS space. By gradually increasing the amount of MTS per superframe, the coordinator 310 can refuse association to any new devices that would make the superframe run out of MTS space. Alternate embodiments can adjust the MTS maximum as needed, or adjust the superframe size, if permissible in that embodiment.

In a preferred embodiment, the network uses a repetition rate of 4 (i.e., a non-coordinator device 320 will have access to an MTS every four superframes) when it has 16 or fewer devices 310, 320 associated in it, and a repetition rate of 8 (i.e., a non-coordinator device 320 will have access to an MTS every eight superframes) is used when the network 300 has more than 16 devices 310, 320 associated in it. If the superframe is 20 ms long, this gives an interval of ˜80 ms (4*20 ms) between MTS for a given non-coordinator device 320 if there are 16 or fewer devices 310, 320 in the network 300, and an interval of ˜160 ms (8*20 ms) between assigned MTS for a given non-coordinator device 320 if there are more than 16 devices 310, 320 in the network 300.

Preferred solutions for the number of MTS per superframe and repetition rate must factor in that the low latency and the low power requirements for non-coordinator devices 320 stand in opposition to each other. In other words, low latency means that a device will have to wait a long time for an MTS. But if the devices 310, 320 are allowed to enter a power-saving sleep mode when not transmitting or receiving, then less frequent MTS means that they devices 310, 320 can remain in the low power sleep mode for a longer time.

In some networks the maximum number of possible associated devices 310, 320 may be greater than the total number of available MTS within the set rotation. As a result, two types of networks can be considered: small and large networks. As used in this application, a small network will be a network in which the number of associated devices 310, 320 does not exceed the total number of available MTS within the superframe rotation, and a large network will be a network in which the number of associated devices 310, 320 does exceed the total number of available MTS within the superframe rotation.

Since the total number of available MTS within the superframe rotation is equal to the maximum number of MTS per superframe multiplied times the maximum repetition rate, the breakpoint between large and small networks will depend upon the values chosen for these two parameters. In the disclosed embodiment having a maximum of 4 MTS per superframe and a maximum repetition rate of 8, the total number of available MTS within the superframe rotation is equal to 32 (i.e., 4*8). Thus, a small network will be one that has 32 or fewer total devices 310, 320 (i.e., 31 associated non-coordinator devices 320 and a coordinator 310), and a large network will be one that has more than 32 total devices 310, 320. However, if different values are chosen for the maximum number of MTS per superframe and the maximum repetition rate, the breakpoint for small and large networks will change accordingly.

It has been observed that large networks are often impractical because of the increased number of non-coordinator devices 320 needing to communicate with the coordinator 310 and each other. Thus, there can never be a perfect solution for large networks 300. However, the disclosed preferred embodiment addresses allocation for network sizes up to 127 associated devices 320, which is extendable to the current maximum the IEEE 802.15.3 standard allows, i.e., 236 devices.

Assignment of MTS in a Small Network

Table 1 indicates how MTS are assigned as new devices become associated with a small network 300, according to a preferred embodiment of the present invention in which the maximum number of MTS per superframe is 4 and a maximum repetition rate is 8. The columns in Table 1 show the beacon number corresponding to the superframes in the repetition schedule; the entries list which devices are assigned an MTS in the superframe designated by that beacon.

As shown in Table 1, with the MTS repetition rate having a maximum value of 8, and each superframe having a maximum of 4 MTS, it is possible to allocate space for 32 devices including coordinator 310 without any need for contention, i.e., each device 310, 320 is assigned its own unique MTS within the superframe rotation. The table below shows how MTS are allocated as new nodes associate.

TABLE 1
Assignment of MTS in a Small Network

| AID/ | Beacon | Beacon | Beacon | Beacon | Beacon | Beacon | Beacon | Beacon |
|---|---|---|---|---|---|---|---|---|
| CGID | #0 | #1 | #2 | #3 | #4 | #5 | #6 | #7 |
| 0 | 0 | ˜ | ˜ | ˜ | X | X | X | X |
| 1 | 0 | 1 | ˜ | ˜ | X | X | X | X |
| 2 | 0 | 1 | 2 | ˜ | X | X | X | X |
| 3 | 0 | 1 | 2 | 3 | X | X | X | X |
| 4 | 0, 4 | 1 | 2 | 3 | X | X | X | X |
| 5 | 0, 4 | 1, 5 | 2 | 3 | X | X | X | X |
| 6 | 0, 4 | 1, 5 | 2, 6 | 3 | X | X | X | X |
| 7 | 0, 4 | 1, 5 | 2, 6 | 3, 7 | X | X | X | X |
| 8 | 0, 4, 8 | 1, 5 | 2, 6 | 3, 7 | X | X | X | X |
| 9 | 0, 4, 8 | 1, 5, 9 | 2, 6 | 3, 7 | X | X | X | X |
| 10 | 0, 4, 8 | 1, 5, 9 | 2, 6, 10 | 3, 7 | X | X | X | X |
| 11 | 0, 4, 8 | 1, 5, 9 | 2, 6, 10 | 3, 7, 11 | X | X | X | X |
| 12 | 0, 4, 8, 12 | 1, 5, 9 | 2, 6, 10 | 3, 7, 11 | X | X | X | X |
| 13 | 0, 4, 8, 12 | 1, 5, 9, 13 | 2, 6, 10 | 3, 7, 11 | X | X | X | X |
| 14 | 0, 4, 8, 12 | 1, 5, 9, 13 | 2, 6, 10, 14 | 3, 7, 11 | X | X | X | X |
| 15 | 0, 4, 8, 12 | 1, 5, 9, 13 | 2, 6, 10, 14 | 3, 7, 11, 15 | X | X | X | X |
| 16 | 0, 1, 16 | 2, 3 | 4, 5 | 6, 7 | 8, 9 | 10, 11 | 12, 13 | 14, 15 |
| 17 | 0, 1, 16 | 2, 3, 17 | 4, 5 | 6, 7 | 8, 9 | 10, 11 | 12, 13 | 14, 15 |
| 18 | 0, 1, 16 | 2, 3, 17 | 4, 5, 18 | 6, 7 | 8, 9 | 10, 11 | 12, 13 | 14, 15 |
| 19 | 0, 1, 16 | 2, 3, 17 | 4, 5, 18 | 6, 7, 19 | 8, 9 | 10, 11 | 12, 13 | 14, 15 |
| 20 | 0, 1, 16 | 2, 3, 17 | 4, 5, 18 | 6, 7, 19 | 8, 9, 20 | 10, 11 | 12, 13 | 14, 15 |
| 21 | 0, 1, 16 | 2, 3, 17 | 4, 5, 18 | 6, 7, 19 | 8, 9, 20 | 10, 11, 21 | 12, 13 | 14, 15 |
| 22 | 0, 1, 16 | 2, 3, 17 | 4, 5, 18 | 6, 7, 19 | 8, 9, 20 | 10, 11, 21 | 12, 13, 22 | 14, 15 |
| 23 | 0, 1, 16 | 2, 3, 17 | 4, 5, 18 | 6, 7, 19 | 8, 9, 20 | 10, 11, 21 | 12, 13, 22 | 14, 15, 23 |
| 24 | 0, 1, 16, 24 | 2, 3, 17 | 4, 5, 18 | 6, 7, 19 | 8, 9, 20 | 10, 11, 21 | 12, 13, 22 | 14, 15, 23 |
| 25 | 0, 1, 16, 24 | 2, 3, 17, 25 | 4, 5, 18 | 6, 7, 19 | 8, 9, 20 | 10, 11, 21 | 12, 13, 22 | 14, 15, 23 |
| 26 | 0, 1, 16, 24 | 2, 3, 17, 25 | 4, 5, 18, 26 | 6, 7, 19 | 8, 9, 20 | 10, 11, 21 | 12, 13, 22 | 14, 15, 23 |
| 27 | 0, 1, 16, 24 | 2, 3, 17, 25 | 4, 5, 18, 26 | 6, 7, 19, 27 | 8, 9, 20 | 10, 11, 21 | 12, 13, 22 | 14, 15, 23 |
| 28 | 0, 1, 16, 24 | 2, 3, 17, 25 | 4, 5, 18, 26 | 6, 7, 19, 27 | 8, 9, 20, 28 | 10, 11, 21 | 12, 13, 22 | 14, 15, 23 |
| 29 | 0, 1, 16, 24 | 2, 3, 17, 25 | 4, 5, 18, 26 | 6, 7, 19, 27 | 8, 9, 20, 28 | 10, 11, 21, 29 | 12, 13, 22 | 14, 15, 23 |
| 30 | 0, 1, 16, 24 | 2, 3, 17, 25 | 4, 5, 18, 26 | 6, 7, 19, 27 | 8, 9, 20, 28 | 10, 11, 21, 29 | 12, 13, 22, 30 | 14, 15, 23 |
| 31 | 0, 1, 16, 24 | 2, 3, 17, 25 | 4, 5, 18, 26 | 6, 7, 19, 27 | 8, 9, 20, 28 | 10, 11, 21, 29 | 12, 13, 22, 30 | 14, 15, 23, 31 |

As Table 1 shows, when there are fewer than sixteen non-coordinator devices 302 associated in the network 300, the superframe cycle (i.e., the MTS repetition rate) is set to 4. Once the sixteenth device associates, however, the superframe cycle interval is doubled from 4 to 8.

The entries marked with “˜” represent available MTS that are not currently needed since there are fewer devices than superframes in the repetition. The coordinator 310 may choose to let other devices 310, 320 currently associated with the network 300 use these MTS, or may simply leave the MTS unassigned.

The assigned MTS numbers are contention group identifiers (CGID). For the first 32 devices (0:31) the CGID will be the same as the association identifier (AID), if no device disassociates. (In effect, the contention groups will only have one entry in each.) It is important however, that the CGID be treated as a separate entity from the AID. In other words, although the AID may initially be similar or identical to the CGID, that may change as the network operation progresses. The coordinator 310 may shuffle the contents of the contention groups as needed to distribute devices across the available MTS.

Assignment of MTS in a Large Network

If more total devices 310, 320 become associated with the network than there are total available MTS in the superframe rotation, then the network 300 is considered to be a large network and some contention will be necessary, i.e., one or more MTS will have more than one device 310, 320 assigned to it. However, it is desirable to limit the amount of possible collisions and thereby increase performance and predictability.

One way this can be done is by assigning contention groups to each MTS, rather than assigning individual devices 310, 320. In operation, the network could create contention group IDs that each reference more than one device. When a device is assigned an MTS in contention (whether by response to an association request or in the normal course of operation within the network 300), the coordinator 310 can indicate this by including a contention group address in a management frame sent to the non-coordinator device 320.

The AID/CGID listed in Table 1 could be interpreted as an AID for a small network and a contention group for a large network. In the alternative, the AID/CGID could be considered a CGID in every case and for small networks each contention group only has a single entry.

Each associating device will preferably get its contention group assignment through an extra entry in the association response frame it receives from the coordinator 310. In an alternate embodiment, the contention group assignments could be announced in the beacon, provided the beacon had enough available space.

Thus, each MTS in the superframe rotation will be assigned to either a single device 310, 320 or a contention group. If the MTS is assigned to a single device 310, 320, then that device uses the MTS as disclosed above. If, however, the MTS is assigned to a contention group, the devices 310, 320 in that group all contend for that MTS as shown above with respect to FIG. 7. The device that “wins” the contention uses the MTS and the devices that “fail” retry according to a desired retry scheme. In the preferred embodiment, if a frame fails in contention, it should be resent using Slotted Aloha in the next MTS assigned to that device 320.

As the network increases in size, more and more of the MTS will be assigned to contention groups rather than individual devices 310, 320, until each MTS is assigned to a contention group.

Preferably the contention groups start as a single pair of devices 310, 320. To accommodate additional devices, the size of the contention groups can be increased up to a maximum contention group size.

As the maximum contention group size increases, the network 300 will see an increased number of collisions and retry attempts, with a corresponding decrease in performance. It is preferable that the maximum contention group size be set to a value that provides an acceptable level of performance (though that “acceptable” level of performance may be poor by normally-accepted criteria.) In one preferred embodiment the maximum contention group size is set to 4 when the maximum number of MTS per superframe is 4 and a maximum repetition rate is 8.

Table 2 indicates how MTS are assigned as new devices become associated with a small network 300, according to a preferred embodiment of the present invention, in which the maximum number of MTS per superframe is 4 and a maximum repetition rate is 8.

TABLE 1
Assignment of MTS in a Small Network

| # of | Beacon | Beacon | Beacon | Beacon | Beacon | Beacon | Beacon | Beacon |
|---|---|---|---|---|---|---|---|---|
| Devices | #0 | #1 | #2 | #3 | #4 | #5 | #6 | #7 |
| 32 | {1, 32}, 2, 17, 25 | 2, 3, 17, 25 | 4, 5, 18, 26 | 6, 7, 19, 27 | 8, 9, 20, 28 | 10, 11, 21, 29 | 12, 13, 22, 30 | 14, 15, 23, 31 |
| 33 | {1, 32}, 2, 17, 25 | {2, 33}, 3, 17, 25 | 4, 5, 18, 26 | 6, 7, 19, 27 | 8, 9, 20, 28 | 10, 11, 21, 29 | 12, 13, 22, 30 | 14, 15, 23, 31 |
| . . . | | | | | | | | |
| 127 | 4 × 4 | 4 × 4 | 4 × 4 | 4 × 4 | 4 × 4 | 4 × 4 | 4 × 4 | 4 × 4 |

As shown in Table 2, as each new device 320 is added, it will be paired up with another existing device 320 to form a contention group. For example, in the preferred embodiment, the 32^{nd} device is paired with the 1^{st} device to form a contention group {1, 32}, which share an MTS. Likewise, the 33^{rd} device is paired with the 2^{nd} device to form the contention group {2, 33}, which share an MTS.

Once all of the devices are in contention groups of two, the next associated device 320 will join a contention group, making it a contention group of three. This will continue until all of the contention groups have three members, after which the next associating device will join a contention group, making it a contention group of four Similarily, this will continue until all of the contention groups have four members, after which the network will be full and the next device requesting association will be refused. This process can obviously be adjusted depending upon the maximum contention group size.

In some embodiments each device 310, 320 will not know if the MTS assigned to it will be used in contention with other devices 310, 320. Therefore, in these embodiments it is preferably that the MAC protocol always be prepared for contention. One way to accomplish this is to require that all short asynchronous data frames sent in an MTS must be sent with an acknowledgement policy set to require acknowledgement (ACK). Such an immediate ACK will preferably carry the device ID of the source address of the “winning” asynchronous data frame as the destination address of the ACK. In this way a requesting device 320 can determine if its frame was acknowledged or if an ACK is intended for a frame from a contending device. The acknowledgement policy for management notifications should also preferably be set to require acknowledgement to assure that the coordinator 310 receives all management notifications.

In this embodiment it is not necessary to set the acknowledgement policy for management request frames, since the response from the coordinator 310, or lack thereof, will unambiguously determine if the request frame was received by the coordinator 310.

In alternate embodiments an extra bit in the MTS channel time allocation (CTA) frame could inform a device 320 whether its MTS is used under contention or not.

Disassociation

One big problem with slot assignment schemes tied to numbered superframes (i.e., numbered beacons) is that unused gaps will appear if several devices disassociate. For example, consider a network 300 whose MTS allocation is assigned according to Table 1. If at one point 17 devices are associated in the network, the MTS will be assigned such that at least two MTS are assigned per superframe. But if devices 2 through 15 disassociate and the MTS allocation remains unchanged, the there will be 7 superframes having no devices assigned MTS and one superframe that has the coordinator 310 (device 0) and two other non-coordinator devices 320 (devices 1 and 16) assigned MTS. This is highly inefficient and should be avoided if possible.

Therefore, in the preferred embodiment the following rules are applied to the coordinator 310 when disassociating devices.

First, it should always reduce the amount of contention when a device 320 dissociates, eliminating contention altogether, if possible. Thus, if there is contention and the device that dissociates is either not in a contention group or is in a contention group that is smaller than any other, the contention groups should be modified to either reduce the size of one of the largest remaining contention groups, or to eliminate the last remaining contention group (if there was only one remaining). With respect to Tables 1 and 2, this can be done by simply changing the device designation of one or more of the remaining devices.

Second, if the amount of total associated devices 310, 320 falls low enough to allow a reduction on the superframe cycle, then the coordinator 310 should do so. In the preferred embodiment disclosed above, when the total number of devices in the network 300 dropped from 17 to 16, the superframe cycle should be dropped from 8 to 4, and the MTS assignments adjusted as necessary.

This can be done through a simple backtracking of the allocation rules, or by any method by which the coordinator can fairly reallocate the MTS. However, the rules used preferably do not have any implication on how the coordinator 310 assigns AID, since the AID and the CGID are decoupled. In other words, no device has any guarantee of being in any particular contention group. Although Tables 1 and 2 show each device assigned to a contention group, this is only by way of example. The coordinator 310 can divide up the devices to various contention groups in as fair away as it can.

It's important not to confuse a CMTS with an MTS under contention. The CMTS is allocated solely for contention. Its purpose is to allow new devices to associate in an empty MTS. The CMTS is preferably assigned to a special “Unassigned” association ID. In contrast, an MTS under contention is simply a regular MTS that has more than one device assigned to it.

In addition, the coordinator 310 can perform load balancing between contention groups as devices dissociate or as the transmission patterns of devices become obvious. For example, if two devices in the same contention group both pass a large amount of management traffic, they might be moved to different contention groups. Similarly, if a number of devices in a single contention group disassociated from the network, the coordinator 310 might move some other devices to fill those decreased contention groups.

Power Saving Sleep Modes

Some networks 300 may allow advanced power saving mechanism in which some non-coordinator devices 320 may enter a sleep mode for a time. In some cases, the sleep mode may be a deep sleep mode that runs for an extended period of time, during which the device 320 will not listen to its assigned MTS. In this case the sleeping device 320 can give up its MTS when it enters the deep sleep mode and reclaim its MTS when it wakes by sending a wakeup frame in the CMTS (it is effectively trying to re-associate with the network 300).

As noted above, these CMTS will be allocated with some periodicity. The coordinator 310 is free to choose any superframe number in the cycle of 4 or 8 to allocate the CMTS. Each CMTS is preferable an extra MTS added every few superframes, in addition to the uplink and downlink MTS provided for the associated devices.

According to a preferred embodiment, when a device 320 enters a sleep mode, the controller operates as follows.

If the deep-sleeping device is alone in an uncontended MTS, the coordinator 310 may deallocate the MTS from the deep-sleeping device and reallocate an MTS to the deep-sleeping device only after it receives a wakeup frame from the deep sleeping device in a CMTS.

If the sleeping device shares the MTS with other devices, i.e., it is in a contention group, the coordinator need take no action. When the deep-sleeping device wakes up, it is free to rejoin the shared MTS as a member of its contention group. This simply means that while it was asleep, the other members of the contention group had a reduced chance of collision.

However, in embodiments where the coordinator 310 does not indicate to the non-coordinator devices 320 whether they are sharing MTS, the wakeup frame must always be sent by a device 320 exiting a deep sleep mode.

Problems Solved

The present invention, as exemplified by the preferred embodiments provides dedicated management frames for small networks and contended frames for large networks. In small networks, forced contention is a waste of time and power. Dedicated MTS are more efficient, since every associated device have their own MTS.

However, dedicated MTS is impossible in large networks where it would require unacceptable amounts of time to assign an MTS to every device. Therefore, contention is used in large networks, but it is a contention scheme based on the use of contention groups. Full contention between a large number of devices would make success unlikely, given the large number of collisions likely. Using contention groups, however, the contention is spread out fairly between all associated devices.

Obviously, numerous modifications and variations of the present invention are possible in light of the above teachings. It is therefore to be understood that within the scope of the appended claims, the invention may be practiced otherwise than as specifically described herein.

We claim:

1. A method of passing management frames between a coordinator and a plurality of devices during a plurality of repeated superframes, comprising:
dividing the plurality of superframes into repeating groups of L consecutive superframes;
forming M management time slots in each of the L consecutive superframes, such that N unique management time slots are created in the L consecutive superframes, where N is equal to L times M;
dividing the plurality of devices into N contention groups;
assigning each of the N contention groups to one of the N unique management time slots;
allowing an individual device from the plurality of devices to send management requests to a network coordinator only during the unique management time slot to which the contention group that the individual device is a member of is assigned,
wherein L and M are integers greater than 0, N is an integer greater than 1.

2. A method of passing management frames between a coordinator and a plurality of devices during a plurality of repeated superframes, as recited in claim 1, wherein each of the N contention groups has no more than one more of the plurality of devices assigned to it than any other of the N contention groups.

3. A method of passing management frames between a coordinator and a plurality of devices during a plurality of repeated superframes, as recited in claim 1, wherein L is between 1 and 16.

4. A method of passing management frames between a coordinator and a plurality of devices during a plurality of repeated superframes, as recited in claim 1, wherein M is between 1 and 8.

5. A method of passing management frames between a coordinator and a plurality of devices during a plurality of repeated superframes, as recited in claim 1, wherein N is between 1 and 64.

6. A method of passing management frames between a coordinator and a plurality of devices during a plurality of repeated superframes, as recited in claim 1, wherein the management time frames are uplink management time frames, used for passing signals from one of the plurality of devices to the network coordinator.

7. A method of passing management frames between a coordinator and a plurality of devices during a plurality of repeated superframes, as recited in claim 1, wherein each of the L repeated superframes further comprises downlink management time slots, used for passing signals from the network coordinator to each of the plurality of devices.
